(19) United States
(12) Patent Application Publication
(10) Pub. No.: US 2016/0224132 A1
(43) Pub. Date: Aug. 4, 2016

(54) METHOD FOR SELECTIVE ACTUATION BY RECOGNITION OF THE PREFERENTIAL DIRECTION

(71) Applicant: STEINBERG MEDIA TECHNOLOGIES GMBH, Hamburg (DE)

(72) Inventors: Dirk Beckmann, Hamburg (DE); Max Schuemann, Hamburg (DE)

(21) Appl. No.: 15/021,112

(22) PCT Filed: Sep. 13, 2013
(86) PCT No.: PCT/EP2013/069030

§ 371 Date: Mar. 10, 2016

(51) Int. Cl. G06F 3/0354

(52) U.S. Cl. CPC G06F 3/0354

(57) ABSTRACT

A selective actuation, in a chronological order, of at least two functions with an input means that is set up to capture at least two-dimensional coupled movements, in that, for each movement section, a preferential direction for the captured movement parallel to or in a direction along a parallel from at least two prescribed, non-parallel straight lines is ascertained and wherein each straight line or each direction along one of the straight lines has precisely one of the at least two functions associated with it, and only the function that is associated with the straight line that is parallel to the preferential direction or with the direction that corresponds to the preferential direction is actuated, and the selective actuation, in chronological order, of the at least two functions involves the use of only that portion of the respective movement section that is directed in the preferential direction in each case.

### BACKGROUND

1. Technical Field

The present invention relates to a method for selective actuation in chronological order of at least two functions with an input means, which is configured to capture movements coupled at least two-dimensionally. It also relates to a method for converting a movement captured with such an input means, and a computer program product, a data carrier and a computer.

2. Background Information

Input means for capturing movements coupled in at least two dimensions are well known from the prior art. By way of example, a computer mouse or trackball is known in this context. But other input means, e.g. that make use of a camera, are also known. They are to be distinguished from input means such as a scroll wheel, which is only configured to capture movement in one dimension. Input means for capturing at least two-dimensionally coupled movements are distinguished in that movement portions in different dimensions can be captured by a single movement. This is the case, for example with joysticks, sensor gloves or optical capturing methods, as long as they are not configured for purely one-dimensional movement. It is the case that the capturing in the input means is frequently still carried out by numerous individual sensors for a one-dimensional capturing of movements. This also relates, however, to an input means for capturing multi-dimensionally coupled movements when at least two such one-dimensional capturings are carried out in order to capture a coupled, multi-dimensional movement. This is the case, for example, when two wheels of an opto-mechanical computer mouse each tap into one-dimensional movements of the mouse ball, and these respective one-dimensional movements are then initially captured individually.

It is the case that, for example, computer mice also have input means for capturing only one-dimensional inputs, e.g. a scroll wheel or buttons, but they also have means for capturing movements that are coupled in at least two dimensions. These means may have different designs. For this, optical scannings, but also mechanical solutions, for example, are known.

With input means of these types, which are configured for capturing two-dimensionally coupled movements, and which this application is concerned with, it is typically the case that they can be freely guided by a user, and therefore, even when the intention is to guide the means in only one direction, usually movement portions occur in another, or numerous other directions, and are captured.

Because in various applications, the movements in different directions have very different effects, or are interpreted differently, a different treatment of such captured two-dimensionally coupled movements is also known. On one hand, the captured movements may be taken, unfiltered and without smoothing, for further processing, and on the other hand, a movement portion can be ignored, or an appropriate smoothing may be carried out. Thus, the detection of a preferential direction in a gesture, which is initiated, for example, through the actuation of a button and holding this button down, and the ignoring of movement portions that deviate from the preferential direction for the duration of the gesture, is known. However, as a result the user must stop the gesture, e.g. by releasing a button, if he wants movement portions in another direction to be captured and processed.

The fundamental problem is that, although a capturing of multi-dimensionally coupled movements is desired, an optimal solution for control tasks is not always depicted in the known implementation. A change to numerous one-dimensional input means, as is likewise the case with the use of data for multi-dimensionally coupled movements captured according to known methods, frequently does not represent a practical solution.

### SUMMARY

The object of the present invention is thus to produce a method, or, respectively, a computer program product, a data carrier, or a computer, which is suited for processing or converting multi-dimensionally coupled movements into control instructions.

This object is achieved by a method for the selective actuation, in chronological order, of at least two functions with an input means, which is configured for capturing at least two-dimensionally coupled movements, wherein movement sections of successive time intervals of the captured movement are acquired, characterized in that for each movement section, a preferential direction of the captured movement, parallel to, or in a direction along a parallel to, at least two prescribed non-parallel straight lines is determined, and wherein each straight line or each direction along one of the straight lines is assigned to exactly one of the at least two functions, and only that function to which the straight line parallel to the preferential direction, or the direction corresponding to the preferential direction, is assigned is actuated, and for the selective actuation in chronological order of the at least two functions, only that portion of the respective movement section directed in the preferential direction is used in each case, and in that the movement of the respective movement section and, as long as this is not the first movement section, the movement of at least one movement section immediately preceding the respective movement section, are used for determining the respective preferential direction of each movement section. The object may also be achieved by the method for converting an at least two-dimensionally coupled movement captured with an input means, which is configured for capturing at least two-dimensionally coupled movements, into a scalar value, and a datum regarding the selection of one of at least two prescribed, non-parallel straight lines or directions, characterized in that a preferential direction of the captured movement parallel to, or in a direction along a parallel to, at least two prescribed, non-parallel straight lines is determined, and wherein each straight line or each direction is assigned exactly one value of the data regarding the selection, and only the portion of the captured movement directed in the preferential direction, or counter thereto, is used as a scalar value, or for its determination. The object may also be achieved by a computer program product for executing the aforementioned methods, a data carrier having the aforementioned computer program product, and a computer or system of computers, configured for executing the aforementioned methods. Advantageous further developments include that the movement sections used for determining the respective preferential direction are weighted; that the respective preferential direction is determined by comparing the portions of the movement of the movement sections used for determining the preferential direction, or the values thereof, parallel to the prescribed straight lines or directions. Furthermore, in order to compare the portions of the movements, the portions parallel to the prescribed straight lines or directions, or their values for the movement sections used for determining the preferential direction, are added up, weighted or un-weighted, and these accumulated portions are compared. Additionally, the direction corresponding to the largest movement, or corresponding in terms of the amount to the greatest portion of the movements, is selected as the respective preferential direction. Furthermore, the respective portion of the captured movement used for the selective actuation is a function of the speed and direction of the captured movement. Still further, the number of dimensions of the space defined by the straight lines corresponds to the number of dimensions in the space in which the input means is configured for capturing coupled movements; and the number of prescribed straight lines or directions for determining the preferential direction is the same as the number of selectively actuatable functions. Finally, the method comprises the capturing of the at least two-dimensional movement using the input means.

The method according to the invention relates to a method for selective actuation of at least two functions, in chronological order, respectively, with an input means, which is configured for capturing movements coupled in at least two dimensions. Thus, functions are successively actuated, wherein each function can clearly be actuated numerous times. It is to be distinguished in a temporal sequence, which of the at least two functions that are available is to be actuated, respectively.

For this, the movement is captured with the input means, and movement sections of successive time periods of the captured movement are acquired. In accordance with the invention, a preferential direction is determined for each movement section. The preferential direction is oriented parallel to, or in a direction along a parallel to, at least two prescribed non-parallel straight lines. According to the invention, the movement of the respective movement section, and, as long as this is not the first movement section, the movement of at least one respective movement section of the movement section immediately preceding the movement section in the sequence, are used to determine the preferential direction.

Each of the non-parallel straight lines, or each direction along one of the non-parallel straight lines, is assigned to precisely one of the at least two functions.

Only the function that is assigned in each case to the straight lines that are parallel to the preferential direction, or the direction corresponding to the preferential direction, is actuated. Only the portion of the respective movement section that is directed in the preferential direction is used thereby to actuate the function that is selected according to this mechanism.

The individual movement sections are advantageously directly adjacent to one another thereby. Movement sections having gaps between them, however, are also conceivable.

Thus, possible preferential directions are to be prescribed, wherein these are defined based on non-parallel straight lines. On one hand, it is possible to regard each straight line as one possible preferential direction, and on the other hand, it is also possible to regard each of the two conceivable directions along a straight line as the preferential direction. In this respect, there are two different possibilities per se for executing the method, wherein the end results thereof are very similar, and differ mostly in terms of their implementation.

By determining a preferential direction for each movement section, and taking preceding movements into account, as long as it is not the first movement, it is possible to generate particularly suitable control data, on the basis of which the functions are actuated. This is because not only is a preferential direction obtained for each movement section based on the data of this movement section, but rather, the preferential directions of the preceding movements continue to act in a defined manner. The user can use the input means, which is configured for the coupled capturing of multi-dimensional movements, very efficiently, and carry out targeted controls, but is not limited excessively thereby. As a result, possibilities arise for the actuation by means of such an input means, which are significantly superior to the known possibilities. Thus, an actuation can be triggered more quickly and precisely. A computer or system of this type is thus particularly efficient and precise.

The method is distinguished thereby in that targeted controls, in different directions, or actuations of different functions, are also possible in a targeted and selective manner, without interruption of a control or gesture, e.g. without pressing or releasing a button. Although, in theory, this would also be possible with two or more decoupled input means, which only capture one-dimensional movements, this would, however, limit the user to a significant extent, or make the operation significantly more difficult. Thus, it is possible, by means of the method according to the invention, or by means of the invention, respectively, to make use of the simple operability of input means for capturing multi-dimensionally coupled movements, without having to sacrifice the precision, or selectivity of numerous individual one-dimensional input means.

An approach of this type may be used, for example, for navigation of displayed data sets, e.g. image or audio data, as well as for the actuation of real machines, e.g. cranes, robots or suchlike.

Particularly advantageously, the movements of a plurality of the respective movement sections directly preceding the respective movement section are used, as long as this is not the first movement section. Immediately successive movement sections are those that are captured, between which there are no other movement sections. If movement sections having gaps between them are captured, then these gaps are ignored, even when regarding the movement sections with respect to their immediate succession.

Particularly advantageously, the movements of the movement sections used for determining the respective preferential direction are weighted. Advantageously, movement sections further in the past are regarded as less important thereby.

Particularly advantageously, the respective preferential direction is determined by a comparison of the portion of the movements of the movement sections used for determining the preferential direction, or their values parallel to the prescribed straight lines or directions. With a comparison of this type, the preceding movements act as though their parts along the prescribed straight lines or directions merge with the determination of the new preferential direction in this regard. Thus, the preceding preferential directions do not act as such, but rather, the earlier movement sections are only taken into account for determining the new preferential direction. This enables a particularly efficient and precise control.

Particularly advantageously, for the comparison of the portions of the movements for determining the preferential direction, in each case the portion parallel to the prescribed straight lines or directions, or their values for the movement sections used for determining the preferential direction, are added up, in a weighted or non-weighted manner, and these accumulated portions are compared.

With one comparison, the preferential direction that conforms to the larger portion of the movements is selected. If the movement portions are identical, an arbitrary selection may be made, or no actuation is carried out.

In particular, it is advantageous when the respective portion of the captured movement for the selective actuation is a function of the speed and direction of the captured movement. Quicker movements in identical time periods thus lead, advantageously, to larger captured movement sections. Furthermore, the portion of the captured movement used for the actuation is a function of the direction thereof in relation to preferential direction determined for the respective movement section.

Advantageously, the number of dimensions of the space defined by the straight lines corresponds to the number of dimensions of the space in which the input means is configured for capturing coupled movements. This is not a selection rule for the number of prescribed straight lines, but rather, it only relates to the number of dimensions in the space through which the straight lines pass. A classical computer mouse is configured, for example, for capturing movements coupled in two dimensions. Thus, it makes sense, in an exemplary manner, to select the prescribed straight lines such that they define a two-dimensional space. With input means that capture movements coupled in a three-dimensional space, as is frequently the case with camera-supported capturings, for example, it makes sense to select the straight lines such that they likewise define a three-dimensional space.

It is, however, also possible to select the number of preferential directions such that it is not identical to the number of dimensions in which the input means is configured for coupled capturing. Thus, it is possible, by way of example, to select three preferential directions in a plane, and to execute the capturing of the input with an input means for capturing movements coupled two-dimensionally. In such a case, one preferential direction may be horizontal and one preferential direction may be vertical, while a third preferential direction runs, respectively, at a 45° angle to these two directions. But the reverse, in which the number of preferential directions is less than the number of dimensions, in which the input means is configured for a coupled capturing, is also conceivable. As such, an arrangement of two preferential directions may be selected, and the capturing of the input may be carried out with an input means, which input means is configured for capturing coupled movements in three-dimensional space.

In theory, the preferential direction can be a movement section and it can be determined in this portion of the movement section pointing in this direction, in that the movement section is projected, respectively, onto the prescribed preferential direction, and the lengths of these projections are compared. The preferential direction is then the longest projected movement section. With numerous identical lengths with respect to different preferential directions, the decision can be made by means of an anomaly rule. The lengths of the projections onto the respective preferential direction then correspond to the portion of the movement section.

Likewise, the number of prescribed straight lines or directions for the determination of the preferential direction advantageously corresponds exactly to the number of selectively actuatable functions.

In particular, advantageously, at least two prescribed straight lines are used for determining the preferential direction and at least two functions are used, which can be selectively actuated. In an alternative implementation, three prescribed straight lines or at least three prescribed directions are advantageously used for determining the preferential direction, and there are at least three functions for selective actuation.

Particularly advantageously, for each determination of a preferential direction, a temporally weighted sliding mean value of the movements or the portions of the movements parallel to the prescribed straight lines or directions, or their values of the respective movement sections referenced for the determination, is generated, and used in each case as the basis for determining the preferential direction.

The object is also achieved by a method for converting the movement coupled in at least two dimensions captured with an input means, which is configured for capturing movements coupled at least two-dimensionally, into a scalar value, and a datum regarding the selection of one of at least two prescribed non-parallel straight lines or directions. A preferential direction of the captured movement parallel to, or in a direction along a parallel to, at least two prescribed non-parallel straight lines is determined thereby, and each straight line or each direction is assigned exactly one value of the data regarding the selection. As the scalar value, or for the determination thereof, only the captured movement in the preferential direction, or the portion of the captured movement directed in, or counter to, the preferential direction, is used.

Advantageously, the method also comprises the use of the scalar value and the data regarding the selection for actuating a procedure, a process, or a machine.

The method also comprises, in particular, the determination of the at least two-dimensional movement using the input means.

Further advantageous designs of the method can likewise be applied in accordance with the embodiments above; where the method is for the selective actuation, in chronological order, of at least two functions with an input means, which is configured for capturing at least two-dimensionally coupled movements, wherein movement sections of successive time intervals of the captured movement are acquired, characterized in that for each movement section, a preferential direction of the captured movement, parallel to, or in a direction along a parallel to, at least two prescribed non-parallel straight lines is determined, and wherein each straight line or each direction along one of the straight lines is assigned to exactly one of the at least two functions, and only that function to which the straight line parallel to the preferential direction, or the direction corresponding to the preferential direction, is assigned is actuated, and for the selective actuation in chronological order of the at least two functions, only that portion of the respective movement section directed in the preferential direction is used in each case, and in that the movement of the respective movement section and, as long as this is not the first movement section, the movement of at least one movement section immediately preceding the respective movement section, are used for determining the respective preferential direction of each movement section.

The object is also achieved by means of a computer program product, configured for executing one of the methods explained above.

Likewise, the object is achieved by means of a data carrier that contains such a computer program product.

Furthermore, the object is achieved by a computer or a computer system, or a system, configured for executing one of the methods described above, having at least one input means, which is configured for capturing at least two-dimensionally coupled movements.

### BRIEF DESCRIPTION OF THE DRAWINGS

Possible embodiments and further advantages shall be explained below, purely on an exemplary basis, and not in a limited manner, on the basis of the examples and one FIGURE.

Thereby:

FIG. 1 shows a schematic depiction of the execution of the method.

### DETAILED DESCRIPTION

By way of example, it is conceivable to move an actuator that can be moved in a plane by means of a classic computer mouse in this plane. In this case, or in general, coordinates for the mouse movement are usually provided by an operating system in certain, not necessarily identical, time intervals.

Two straight lines can then be prescribed, which are perpendicular to one another. The portions of the mouse movement along these straight lines, based on the coordinates provided by the operating system, can then be added together, weighted according to their amount, and compared, respectively. Such an approach could be depicted for the components along a straight line in the following formula:

$${\sum }_{i = 1}^{t} {w}_{i} \vert ( {y}_{i} - {y}_{i - 1} ) \vert$$

Yᵢ represents the respective position projected onto one of the prescribed straight lines. The index i runs from the first movement section (t =1) to the current time t, or the current movement section, respectively. Wᵢ represents the weighting factor thereby, which can be assumed to be 0.9^{t-(i-1)} for all i<t and as 0.1 for t=i. The weighting factor can, however, also be selected differently, depending on the desired implementation. Advantageously, however, it assumes lower values for movements occurring further in the past.

Based on the preceding value, the following depiction is then obtained, written differently, for example:

Yₜ=Yₜ₋₁0.9+|(yⁱ−yᵢ₋₁)(1−0.9)|

The portions along the prescribed straight lines, which have been added up in terms of their values and weightings, can then be compared with one another.

If the portion along the first straight line is greater than the portion along the second, then the first straight line is selected as the preferential direction, and vice versa. When they are identical, then an arbitrary straight line can be selected as the preferential direction, or it may be that no action is carried out.

If the preferential direction is determined, the function assigned to the preferential direction is retrieved with the corresponding value. The value is determined based on the portion of the movement along the preferential direction. If, for example, the Y-portion is greater, then the preferential direction corresponding to this portion, thus the second straight line is selected as the preferential direction in this case, by way of example.

The individual preferential directions or straight lines are assigned to corresponding functions. In this case, the function to which the first straight line is assigned can be the movement of the actuator along the x-axis, and the movement to which the second straight line is assigned can be the function for moving the actuator along the y-axis.

In this case, the function for moving along the y-axis is then actuated with the value, or based on the value:

(yᵢ−yᵢ₋₁)

“Based on a value,” means that the value for actuating the function can be modified in a predetermined manner, e.g. scaled.

If a movement, for example, only occurs when a mouse button is actuated, then the corresponding steps are only executed with those coordinates that come from movements occurring while the mouse button is being pressed down.

Alternatively to the adding up of the amounts, the absolute values of the movements along the prescribed straight lines can also be added up.

It would also be conceivable to work with directions along the straight lines, and to break down the portions of the movement, in each case, in the positive or negative direction on one of the two straight lines, and to add these up separately, accordingly. Four functions would then be obtained, of which one, in each case, is assigned a direction along a straight line. The functions could also be configured to move the actuator, respectively, in a direction along the x-axis or in a direction along the y-axis. It is clear from these embodiments that the results of the various implementations, with respect to the use of straight lines as the preferential direction, or directions on straight lines as the preferential direction, frequently do not differ, or differ only slightly, as long as, otherwise, the absolute values of the movement portions, and not the quantities for the values of the movement portions, are added up. A clear difference, however, can be observed if a comparison is made in which the values of the movement portions are added up, or if a comparison is made in which the values of the movement portions are added up directly. Then, when the amounts are added up, movements of the computer mouse along a straight line, but with different algebraic signs, are added up as amounts, and collectively reinforce, thereby, a preferential direction. If the absolute values are added up, then the movements in opposing directions along a straight line cancel each other out, and thus do not reinforce this preferential direction, but rather behave in a substantially neutral manner with respect to the determination of a preferential direction.

An alternative application of the method, however, which can be developed on the execution explained above, depicts the navigation within an image. By way of example, a first straight line can be assigned to the displacement of the image section along the x-axis, and a second straight line can be assigned to the displacement of the image section along the y-axis, as a function.

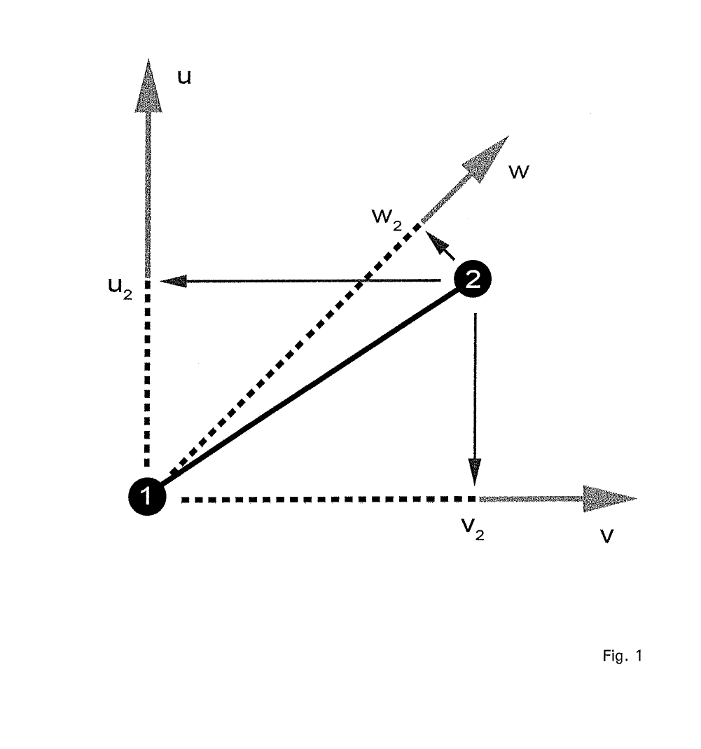

Alternatively, by way of example, a color selection in a depiction of an HSV, HSL, or HSI color space can be executed with an appropriate method. If the input means is suitable for capturing movements coupled three-dimensionally, then all portions can be controlled with this method. If the input means is configured only for capturing movements coupled two-dimensionally, then, in particular, the selection of the H and S components can be controlled by this method. Likewise, navigation in a depiction of audio data is also possible. As such, a function assigned to a first straight line can be used for navigation on the time axis, and a second function, which is assigned to a second straight line, can be configured for zooming in and out. FIG. 1 shows a schematic depiction of the execution of the method. Three prescribed preferential directions u, w, v are depicted as arrows. Furthermore, a movement section from point 1 to point 2 is also depicted. The projections of the movement section onto the three prescribed preferential directions u, v, w are indicated by a broken line, labeled as u₂, v₂, w₂. The projection w₂ is the longest. Thus, w is the preferential direction of the movement section from point 1 to point 2. The length of the projection w₂, or the projection w₂, respectively, represents the portion of the movement section that is to be used.

1. A method for the selective actuation, in chronological order, of at least two functions with an input means, which is configured for capturing at least two-dimensionally coupled movements, wherein movement sections of successive time intervals of the captured movement are acquired, and wherein the method comprises that for each movement section, a preferential direction of the captured movement, parallel to, or in a direction along a parallel to, at least two prescribed non-parallel straight lines is determined, and wherein each straight line or each direction along one of the straight lines is assigned to exactly one of the at least two functions, and only that function to which the straight line parallel to the preferential direction, or the direction corresponding to the preferential direction, is assigned is actuated, and for the selective actuation in chronological order of the at least two functions, only that portion of the respective movement section directed in the preferential direction is used in each case, and in that the movement of the respective movement section and, as long as this is not the first movement section, the movement of at least one movement section immediately preceding the respective movement section, is used for determining the respective preferential direction of each movement section.

2. The method according to claim 1, wherein the movements of the movement sections used for determining the respective preferential direction are weighted.

3. The method according to claim 1, wherein the respective preferential direction is determined by comparing the portions of the movement of the movement sections used for determining the preferential direction, or the values thereof, parallel to the prescribed straight lines or directions.

4. The method according to claim 3, wherein, in order to compare the portions of the movements, the portions parallel to the prescribed straight lines or directions, or their values for the movement sections used for determining the preferential direction, are added up, weighted or un-weighted, and these accumulated portions are compared.

5. The method according to claim 3, wherein the direction corresponding to the largest movement, or corresponding in terms of the amount to the greatest portion of the movements, is selected as the respective preferential direction.

6. The method according to claim 1, wherein the respective portion of the captured movement used for the selective actuation is a function of a speed and direction of the captured movement.

7. The method according to claim 1, wherein the number of dimensions of a space defined by the straight lines corresponds to the number of dimensions in the space in which the input means is configured for capturing coupled movements.

8. The method according to claim 1, wherein the number of prescribed straight lines or directions for determining the preferential direction is the same as the number of selectively actuatable functions.

9. The method according to claim 1, wherein the method comprises the capturing of the at least two-dimensional movement using the input means.

10. A method for converting an at least two-dimensionally coupled movement captured with an input means, which is configured for capturing at least two-dimensionally coupled movements, into a scalar value, and a datum regarding the selection of one of at least two prescribed, non-parallel straight lines or directions, wherein a preferential direction of the captured movement parallel to, or in a direction along a parallel to, at least two prescribed, non-parallel straight lines is determined, and wherein each straight line or each direction is assigned exactly one value of the data regarding the selection, and only the portion of the captured movement directed in the preferential direction, or counter thereto, is used as a scalar value, or for its determination.

11. The method according to claim 10, wherein the method comprises the capturing of the at least two dimensional movement using the input means.

12. A computer program product, configured for executing the method according to claim 1.

13. A data carrier, having a computer program product according to claim 1.

14. A computer or system of computers, configured for executing the method according to claim 1, having at least one input means, which is configured for capturing at least two-dimensionally coupled movements.

15. A computer program product, configured for executing the method according to claim 10.

16. A computer or system of computers, configured for executing the method according to claim 10, having at least one input means, which is configured for capturing at least two-dimensionally coupled movements.
